(19) United States
(12) Patent Application Publication
(10) Pub. No.: US 2016/0278369 A1
(43) Pub. Date: Sep. 29, 2016

(54) MOULDED ARTICLE FOR COMBATING VARROA MITES

(71) Applicant: BAYER ANIMAL HEALTH GMBH, Leverkusen (DE)

(72) Inventors: Klemens KRIEGER, Lindlar (DE); Reinhold LÖHR, Bergisch Gladbach (DE); Wolfgang JIRITSCHKA, Leichlingen (DE); Nikolaus KOENIGER, Oberursel (DE); Gudrun KOENIGER, Oberursel (DE)

(21) Appl. No.: 14/442,662

(22) PCT Filed: Nov. 11, 2013
(86) PCT No.: PCT/EP2013/073518

§ 371 Date: May 13, 2015

(30) Foreign Application Priority Data
Nov. 13, 2012 (EP) 12192358.5
Jul. 12, 2013 (EP) 13176238.7

(51) Int. Cl. A01N 25/08; A01N 57/16; A01N 35/10; A01N 53/00

(52) U.S. Cl. CPC A01N 25/08; A01N 53/00; A01N 57/16; A01N 35/10

(57) ABSTRACT

The present invention relates to shaped articles which are suitable for controlling Varroa mites in bees.

The present invention relates to shaped articles which are suitable for controlling Varroa mites in bees.

The parasitic honeybee mite Varroa destructor is a natural parasite of the Asiatic honeybee species Apis cerana. Besides the Asiatic honeybee, there is only the European honeybee, Apis mellifera, which is suitable for beekeeping by humans. The natural ranges of both honeybee species are separated from each other by the deserts and mountain ranges of the Near and Middle East. Only by transferring colonies of the European honeybees into the natural range of the Asiatic honeybee was it possible for the mites, in the last century, also to parasitize this new host and to spread together with it on all continents with the exception of Australia and Antarctica. As opposed to their natural host, the mites are capable of multiplying both on the male brood, the drone larvae and pupae, which are preferred by the mites, and on the female worker larvae and pupae. In contrast to the Asiatic bee, there are no natural limits to their multiplication. Firstly, the bee brood is damaged directly by the haematophagous mites, but the mites are also vectors of pathogens of bacterial and viral infections, also resulting in indirect damage. Without effective mite control, the bee colonies die sooner or later.

Suitable control measures are biotechnological measures such as removing and destroying the drone brood, which is preferred by the mites, and chemotherapeutic measures, i.e. the application of substances and of preparations of substances which selectively kill the mites, but leave the bees unharmed. During the reproduction, however, most of the mites are in the brood cells which are sealed by a thin wax lid, where they are not amenable to control products. Only during the time during which the queen bee does not lay eggs and the bees do not establish any brood are all mites on adult bees, where they are amenable to treatment. Preparations with a short duration of action must therefore be employed during the brood-free time of the bee colonies. Most of the bee colonies, however, die in late summer and autumn, when more and more mites become concentrated in a lessening number of brood cells, owing to the lessening of the bees' breeding activity, thus inflicting long-term damage on the bee brood.

Against this background, the development of vapourizer systems of organic acids and essential oils and of polymer matrix active-substance supports, which release on the surface the active substance incorporated into the matrix over a period of several weeks, was a huge progress. These active-substance supports are placed between the bee colonies' honeycombs in such a way that the bees can crawl on both sides, during which process the active substance is mechanically removed from the surface of the active-substance supports and is distributed within the beehive by the bees as the result of social body contact. This is how it also reaches the Varroa mites. The mites, which have been protected during their reproduction phase in the brood cells from the Varroacidal treatment, are controlled sustainably after they have hatched.

More recent studies (Grünewald B; Fuchs S (2011): AREA-WIDE VARROA TREATMENTS WITH ALTERNATING COUMAPHOS AND FLUMETHRIN ON HONEYBEE COLONIES: A FIELD STUDY IN GERMANY. Poster Apimondia Congress Buenos Aires.) demonstrate that a high-degree Varroa mite transfer from bee colonies with a high degree of infection to bee colonies with a low degree of infection (colonies which have been treated successfully) may result in late summer after the honey has been harvested. That means that a successful summer treatment of the bee colonies (for example with formic acid) does not offer sufficient protection until the winter treatment during the nonreproductive time. The shaped articles described herein are intended to protect bee colonies from a mite transfer from severely infected colonies of other beehives, thus allowing healthy overwintering of the bee colonies.

WO00/72683 has already disclosed a method of controlling parasitosis in bees, using a combination of coumaphos with a plastic material, for example in the form of coumaphos-containing plastic strips which can be hung in a beehive.

WO02/23981 already relates to an antiparasitic bee lock for beehives, which bee lock, however, could be improved even further.

WO2006/00335 describes active-substance-containing solid shaped articles for external use against parasites on animals.

The invention relates to:

1. Solid shaped articles based on a polyvinyl chloride matrix containing
0.1 to 30% by weight of an acaricidal active substance
1 to 30% by weight of a glycerol ester or propylene glycol ester with C₈-C₁₂-fatty acids
and optionally further adjuvants and additives,
where the shaped articles have a thickness from 0.5 to 20 mm and include openings with a diameter of 6-9 mm

In a further embodiment, the invention relates to:

2. Solid shaped articles based on a polyvinyl chloride matrix containing
0.1 to 30% by weight of an acaricidal active substance selected from among flumethrin, coumaphos and amitraz
1 to 30% by weight of caprylic/capric acid triglyceride or propylene glycol dicaprylate/dicaprate
and optionally further adjuvants and additives, where the shaped articles have a thickness from 0.5 to 20 mm and include openings with a diameter of 6-9 mm.

The shaped articles contain an acaricidal active substance with as low as possible a bee toxicity. Suitable acaricidal active substances which may be mentioned are: cymiazole, etoxazole, fluvalinate and in particular flumethrin, coumaphos and amitraz.

The shaped articles usually contain the acaricidal active substance in concentrations of in each case from 0.1 to 30% by weight, preferably from 0.2 to 20% by weight, especially preferably from 0.5 to 15.0% by weight, based on the total weight of the solid formulation. Preferred concentration ranges for the use of the various acaricidal active substances:

flumethrin: 0.1 to 5% by weight, especially preferably 0.5 to 2% by weight or, as per a further especially preferred embodiment, 0.5 to 2.5% by weight

coumaphos: 6 to 12% by weight, especially preferably 5 to 10% by weight or, as per a further embodiment, 5 to 20% by weight, especially preferably 7 to 15% by weight

etoxazole: 6 to 12% by weight, especially preferably 5 to 10% by weight,

fluvalinate: 6 to 12% by weight, especially preferably 5 to 10% by weight,

amitraz: 1 to 10% by weight, especially preferably 2 to 6% by weight,

cymiazole: 1 to 10% by weight, especially preferably 2 to 6% by weight.

The shaped articles according to the invention contain a glycerol ester or propylene glycol ester with C₈-C₁₂-fatty acids; these are preferably aliphatic, unbranched saturated fatty acids, such as, for example, caprylic acid, capric acid or lauric acid. In these esters, all hydroxyl groups of the underlying alcohol are preferably esterified, that is to say they are propylene glycol diesters or triglycerides. Preferred examples of such esters which may be mentioned are caprylic/capric acid triglyceride (Miglyol 812) and propylene glycol dicaprylate/dicaprate. The shaped articles according to the invention contain the glycerol ester or propylene glycol ester with C₈-C₁₂-fatty acids in amounts of from 1 to 30% by weight, preferably 5 to 25% by weight, especially preferably 7 to 25% by weight, very especially preferably 15 to 25% by weight (based on the respective total weight of the mixture). Caprylic/capric acid triglyceride (Miglyol 812, from Sasol Germany GmbH/Witten, CAS No. 73398-61-5) is also known by the name MCT (medium-chain triglycerides). Propylene glycol dicaprylate/dicaprate (Miglyol 840 from Sasol/Witten, CAS No. 68583-51-7) is the propylene glycol diester of caprylic and capric acid, in the German Pharmacopoeia 9 (DAB 9) it is described as propylene glycol octanoate decanoate. In the usual qualities of the two esters, small amounts of C₆- and C₁₂-fatty acids are also esterified. See also the entries “Miglyol 812-Neutralöl” and “Miglyol 840” in H. P. Fiedler, Lexikon der Hilfsstoffe, Editio Cantor Verlag Aulendorf, 4^{th} revised and expanded edition, 1996, Vol. 2, p. 1008/1009.

The shaped articles according to the invention with propylene glycol dicaprylate/dicaprate are preferred.

Suitable support materials or bases for the shaped articles are, in principle, flexible thermoplastic polyolefins (for example polyethylene) or polyvinyl resins. It is especially advantageous to employ polyvinyl chloride homopolymer (PVC).

If appropriate, the shaped articles according to the invention may additionally contain customary plasticizers which are customarily used for plasticizing solid polyvinyl chloride resins. Examples of suitable additional plasticizers are phosphoric esters, adipic esters such as, for example, diisobutyl adipate and n-butyl adipate. Other esters, such as the esters of azelaic acid, maleic acid, ricinoleic acid, myristic acid, palmitic acid, oleic acid, sebacic acid, stearic acid and trimellitic acid, and complex linear polyesters, polymeric plasticizers and epoxidized soya oils, may also be used. Preferred are adipic esters, in particular di-n-butyl adipate. The additional plasticizers are employed in amounts of from 4 to 45% by weight, preferably 10 to 40% by weight.

For example, epoxidized soya oil is preferably employed in concentrations of from 1 to 5% by weight, especially preferably 1 to 3% by weight, based on the total composition.

In accordance with a preferred embodiment, the additional plasticizer employed is a di-C₁₋₆-alkyl ester of a C₂₋₈-dicarboxylic acid, in particular di-n-butyl adipate, in concentrations of from 1 to 30% by weight, preferably 7 to 22% by weight. In these cases, the glycerol ester or propylene glycol ester with C₈-C₁₂-fatty acids and the di-C₁₋₆-alkyl ester of a C₂₋₈-dicarboxylic acid are preferably present at a concentration of in total 5 to 35% by weight.

The total amount of plasticizer, i.e. the amount of caprylic/capric acid triglyceride or propylene glycol dicaprylate/dicaprate in addition to the amount of additional plasticizers, should not exceed 50% by weight, preferably 45% by weight, especially preferably 35% by weight. The total amount of plasticizers is therefore in the ranges of from approximately 5 to 50% by weight, preferably approximately 15 to 45% by weight, especially preferably 15 to 35% by weight of the total composition. In accordance with a further especially preferred embodiment, the total amount of plasticizer does not exceed 40% by weight of the total composition, and in this case the total amount of plasticizer accounts for 15 to 40% by weight.

Other customary constituents such as stabilizers, lubricants, releasing agents, fillers and colorants, may additionally be present in the shaped articles; as a rule, they do not substantially alter the basic properties of the composition.

Suitable stabilizers are antioxidants and agents which protect the tapes from ultraviolet radiation and undesired degradation during processing, such as extruding. Some plasticizers such as epoxidized soya oil simultaneously act as stabilizers.

Lubricants which can be used are, for example, stearic acid or its salts (stearates) or low-molecular-weight polyethylenes. It is preferred to use stearic acid. These constituents are usually employed in a concentration of up to 5% by weight, preferably up to 3% by weight of the total composition.

Unless otherwise specified, percentages are understood as meaning per cent by weight based on the total mixture. The “total mixture” is the finished composition which is then shaped by suitable methods.

The shaped articles are preferably prepared by melt extrusion, extrusion or injection moulding.

The choice of the processing method for preparing the shaped articles technically depends in principle on the rheological properties of the polymeric support material and on the shape of the desired shaped article. The processing methods can be categorized in accordance with the processing technology or in accordance with the nature of the shaping. In the case of the processing technology, the processes can be divided on the basis of the rheological states which are passed through in these processes. Accordingly, casting, pressing, injection-moulding and spreading-on come into consideration for viscous polymeric support materials, while injection-moulding, extruding, calendering, rolling and, where appropriate, kneading come into consideration in the case of elastoviscous polymers. Classified in accordance with the nature of the shaping, the shaped articles according to the invention may be prepared by casting, dipping, pressing, injection-moulding, extruding, calendering, stamping, bending, thermoforming and the like. Coating of solid basic supports also comes into consideration. The shaped articles can be adapted to their functional requirement by finishing.

These processing methods are known per se and do not require any more detailed explanation.

The solid shaped articles according to the invention usually have a material density of from 0.5 to 20 mm, preferably 0.5 to 10 mm, especially preferably 1 to 5 mm, very especially preferably 1 to 3 mm.

Beehives may come in different shapes and be composed of different materials. A beehive is understood as meaning here the housing for in each case one bee colony. The shaped articles according to the invention preferably have a shape which matches the entrance of customary beehives and forms a sort of lock. The shaped articles have openings and are shaped such that the bees, when leaving the beehive and returning into the beehive, are forced to pass through these openings The openings usually have a diameter of from 5 to 9 mm, preferably 6 to 8 mm, especially preferably 6.5 to 7.5 mm. To ensure adequate aeration of the beehive, the openings in total should account for an area of from 5 to 26 cm², preferably 10 to 15 cm², per beehive. The conclusion is that approximately 10 to 100 openings, preferably 15 to 80 openings, especially preferably 15 to 60, very especially preferably 25 to 40, in particular 20 to 30 openings, should be present per beehive (with one entrance). The number and size of the openings must be chosen such that the beehive is adequately aerated even at extreme temperatures and that they do not form a mechanical obstacle, for example when removing dead drones (male bees).

The shape and size of the shaped articles according to the invention should be chosen such that they match the entrances of customary beehives. For example, they can be rectangular in shape with a height of from 1 to 10 cm, preferably 1.5 to 4 cm, in particular 2 to 4 cm or in particular 1.5 to 2.5 cm and width of from 10 to 50 cm, preferably 15 to 40 cm.

When used in practice, the shaped articles according to the invention can be attached to the beehive in a manner known per se so that the bees, when returning to, or leaving, the beehive, must pass through the openings in the shaped article as a form of lock. To attach them to the beehive or a mounting, one may use, for example, fastening devices such as nails, drawing pins, screws or adhesive. Other devices, for example those where the shaped articles according to the invention are inserted into guiding means, are also feasible. Also feasible is a suitable rest on which the shaped article according to the invention can be fitted in a simple manner; the rest in turn is constructed such that it together with the shaped article can be fitted readily on the beehive.

Surprisingly, the shaped articles according to the invention display an outstanding activity against Varroa mites in bees when the shaped articles are fitted in the above-described manner at the entrance of the beehive.

The shaped articles according to the invention are distinguished by the fact that they are well tolerated by bees. When passing through the shaped articles, the Varroa mites are killed either directly or after a certain period of time has elapsed. If the mites are not killed directly, it will, however, as a rule, at least be possible to prevent the mites from reproducing further. There are indications that the use of propylene glycol dicaprylate/dicaprate improves the tolerance, by bees, of the shaped articles. Owing to the chemical similarity, it can be assumed that caprylic/capric acid triglyceride, too, improves the tolerance by the bees.

There are indications that shaped articles according to the invention which contain flumethrin are particularly effective. It appears that the bees are protected by flumethrin one way or the other against infestation by Varroa mites, i.e. there are indications that bees which have passed through a flumethrin-containing shaped article according to the invention are provided with a certain protection against infestation with Varroa mites which lasts for some time.

There are furthermore indications that propylene glycol dicaprylate/dicaprate per se, too, protects the bees from infestation by Varroa mites. It can be assumed that this also applies to caprylic/capric acid triglyceride.

In accordance with a further embodiment, the invention therefore relates to shaped articles as described further above which do not contain any acaricidal active substance.

It is expected that bees which pass through these shaped articles without acaricidal active substance are provided with a certain protection against infestation by Varroa mites.

Bees are the Asiatic honeybee (Apis cerana) and, in particular, the European honeybee (Apis mellifera).

Varroa mites are, in particular, Varroa destructor.

Since the function of the shaped articles according to the invention is based especially on the fact that the bees pass through the openings, it makes sense to employ them especially during the bees' foraging time. However, it is not necessarily required to remove the shaped articles outside the foraging period.

When employing the shaped articles according to the invention it may be recommendable to alternate shaped articles which contain active substances with different mechanisms of action, so as to avoid the development of resistance.

### EXAMPLES

### Example 1

Composition:

| | | |
|---|---|---|
| Flumethrin | 2.5% | by weight |
| Di-n-butyl adipate | 8.9% | by weight |
| Propylene glycol octanoate decanoate (Miglyol 840) | 20% | by weight |
| Epoxidized soya oil | 1.1% | by weight |
| Stearic acid | 2% | by weight |
| PVC | 64.5% | by weight |
| Titanium dioxide | 1% | by weight |

Preparation:

In a mixer, the mixture of titanium dioxide and PVC is mixed with the mixture of di-n-butyl adipate, propylene glycol octanoate decanoate, epoxidized soya oil and flumethrin. Mixing is continued with exposure to heat until the mixture is homogeneous. Heating promotes the migration of the active substance/plasticizer mixture into the PVC. After the subsequent homogeneous distribution of the stearic acid, the mixture can be processed with methods known per se to give shaped articles in the desired thickness.

Shaped articles which are suitable for use in beehives were prepared. These shaped articles have the following dimensions:

Length: 15 cm, width: 3 cm, thickness: 2 mm.

The shaped articles include 15 openings, each with a diameter of 7 mm

### Example 2

Composition:

| | | |
|---|---|---|
| Coumaphos | 7.5% | by weight |
| Di-n-butyl adipate | 8.9% | by weight |
| Propylene glycol octanoate decanoate (Miglyol 840) | 20% | by weight |
| Epoxidized soya oil | 1.1% | by weight |
| Stearic acid | 2% | by weight |
| PVC | 59.5% | by weight |
| Titanium dioxide | 1% | by weight |

In a mixer, the mixure of titanium dioxide, PVC and coumaphos is mixed with the mixture of di-n-butyl adipate, propylene glycol octanoate decanoate and epoxidized soya oil. Mixing is continued with exposure to heat until the mixture is homogeneous. Heating promotes the migration of the active substance/plasticizer mixture into the PVC. After the subsequent homogeneous distribution of the stearic acid, the mixture can be processed with methods known per se to give shaped articles in the desired thickness.

Shaped articles which are suitable for use in beehives were prepared. These shaped articles have the following dimensions:

Length: 15 cm, width: 3 cm, thickness: 2 mm.

The shaped articles include 15 openings, each with a diameter of 7 mm

### Examples 3 to 16

Further compositions which are suitable for the preparation of solid shaped articles according to the invention are specified in the table hereinbelow as Examples 3 to 12 and 14 to 16. Example 13 is a placebo formulation.

| | Ex. No. | | | | | | | |
|---|---|---|---|---|---|---|---|---|
| | 3 | 4 | 5 | 6 | 7 | 8 | 9 | 10 |
| Constituents | | | | | | | | |
| Flumethrin | 2.6 | 2.1 | 2.0 | 2.0 | 2.0 | 2.0 | 2.5 | 2.5 |
| Propylene | 20.0 | 24.3 | 15.0 | 20.0 | 15.0 | 10.0 | 10.0 | 15.0 |
| glycol | | | | | | | | |
| octanoate | | | | | | | | |
| decanoate | | | | | | | | |
| Di-n-butyl | 8.9 | 0 | 20.0 | 10.0 | 10.0 | 20.0 | 20.0 | 20.0 |
| adipate | | | | | | | | |
| Epoxidized | 1.1 | 1.3 | 2.0 | 2.0 | 2.0 | 2.0 | 2.0 | 2.0 |
| soya oil | | | | | | | | |
| Stearic acid | 2.0 | 2.0 | 1.0 | 1.0 | 1.0 | 1.0 | 1.0 | 1.0 |
| Titanium | 0.05 | 0.05 | 0.05 | 0.05 | 0.05 | 0.05 | 0.05 | 0.05 |
| dioxide | | | | | | | | |
| Iron oxide | 0.08 | 0.08 | 0.08 | 0.08 | 0.08 | 0.08 | 0.08 | 0.08 |
| pigments | | | | | | | | |
| PVC | q.s. | q.s. | q.s. | q.s. | q.s. | q.s. | q.s. | q.s. |

| | Ex. No. | | | | | |
|---|---|---|---|---|---|---|
| | 11 | 12 | 13 | 14 | 15 | 16 |
| Constituent | | | | | | |
| Flumethrin | 2.5 | 2.5 | — | 5.0 | 4.0 | 3.0 |
| Propylene | 20.0 | 15.0 | 10.2 | 20.0 | 20.0 | 20.0 |
| glycol | | | | | | |
| octanoate | | | | | | |
| decanoate | | | | | | |
| Di-n-butyl | 10.0 | 10.0 | 20.4 | 8.9 | 8.9 | 8.9 |
| adipate | | | | | | |
| Epoxidized | 2.0 | 2.0 | 2.0 | 1.1 | 1.1 | 1.1 |
| soya oil | | | | | | |
| Stearic acid | 1.0 | 1.0 | 1.0 | 2.0 | 2.0 | 2.0 |
| Titanium | 0.05 | 0.05 | 0.05 | 1.0 | 1.0 | 1.0 |
| dioxide | | | | | | |
| Iron oxide | 0.08 | 0.08 | 0.08 | — | — | — |
| pigments | | | | | | |
| PVC | q.s. | q.s. | q.s. | q.s. | q.s. | q.s. |

(In the tables, the amounts of constituent are specified in % by weight)

The compositions of Examples 3 to 16 can be prepared analogously to the composition of Example 1. Alternatively, PVC, titanium dioxide and iron oxide pigments may be mixed with heating (60° C.), and then a solution of the remaining constituents, with the exception of stearic acid, is prepared and admixed to the warm PVC/pigment mixture. Finally, stearic acid is also added with further stirring and heating, and a homogeneous composition is prepared which, after cooling, can be processed further.

The finished compositions can be used for preparing solid shaped articles according to the invention, for example as specified in Example 1.

### Biological Example

### Example A

To assess the efficacy of flumethrin-containing active-substance supports (shaped articles) according to the invention, made of PVC, at the entrance of beehives, on 6 Apr. 2012, 12 reproducing bee colonies in Zander beehives were provided with in each case 2 approximately 15 cm long, approximately 2.5 cm wide and approximately 2 mm thick active-substance supports which were provided with 30 openings of diameter 7 mm and which were positioned at the entrance in such a way that the bees could leave, or return to, the beehive exclusively through the openings of the active-substance supports. In each case 3 colonies received active-substance supports with a flumethrin content of 3%, 4% and 5%, respectively (Ex. 16, 15 and 14, respectively). Three bee colonies acted as control colonies and were equipped with active-substance-free supports. Between 6 April and 2 May, the dead mites were recorded daily with the aid of insertions which covered all of the hive bottom below the hive's honeycomb seat and which was only covered by a metal grid through which dropping mites, but not honeybees, were able to pass.

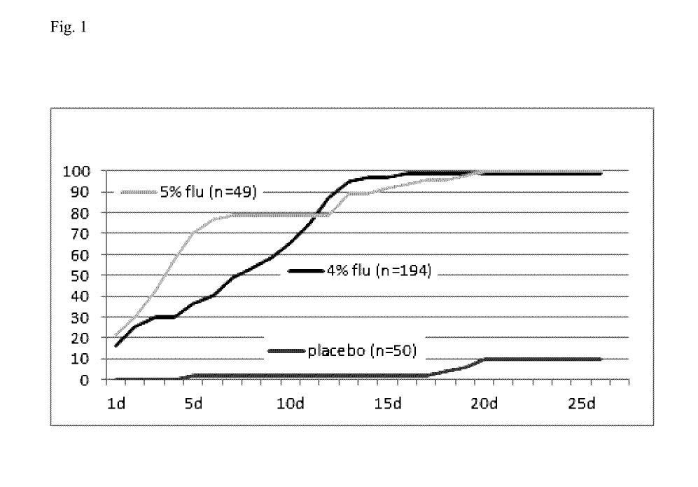

The entire mite death rate recorded for the various treatment groups and colonies is compiled in Table 1 hereinbelow. The lines designated A, B and C contain the efficacies in per cent for in each case one bee colony (n Varroa). The mite death rate's course over the observation period is shown for selected colonies in the graphic representation (FIG. 1) (owing to the low total death rate in the 3% group, a graphic representation was dispensed with). The data support the Varroacidal effect of the bee colonies' treatment with the flumethrin-containing active-substance support.

TABLE 1

| | Placebo | 5% Flu | 4% Flu | 3% Flu |
|---|---|---|---|---|
| A | 0 (11) | 100 (3) | 66.67 (3) | 90 (10) |
| B | 50 (4) | 100 (49) | 98.97 (194) | 100 (2) |
| C | 10.41 (50) | 100 (7) | 90 (10) | 100 (3) |

1. A solid shaped article5 of a polyvinyl chloride matrix comprising
0.1 to 30% by weight of an acaricidal active substance,.
1 to 30% by weight of a glycerol ester or propylene glycol ester with C₈-C₁₂-fatty acids, and
optionally an adjuvant or additive,
wherein the shaped article has a thickness from 0.5 to 20 mm and includes one or more openings passing therethrough having a width of 6-9 mm.

2. A solid shaped article according to claim 1, wherein the acaricidal active substance is cymiazole, etoxazole, fluvalinate, flumethrin, coumaphos or amitraz.

3. A solid shaped article according to claim 1, wherein
as the acaricidal active substance is flumethrin, coumaphos or amitraz, and
the glycerol ester or propylene glycol ester with C₈-C₁₂-fatty acids is caprylic/capric acid triglyceride or propylene glycol dicaprylate/dicaprate.

4. A solid shaped article according to claim 1, wherein the acaricidal active substance is flumethrin.

5. A solid shaped article according to claim 4, containing 0.1 to 5% by weight of flumethrin.

6. A solid shaped article according to claim 1, wherein the acaricidal active substance is coumaphos.

7. A solid shaped article according to claim 6, containing 6 to 12% by weight of coumaphos.

8. A solid shaped article according to claim 1, wherein the acaricidal active substance is amitraz.

9. A solid shaped article according to claim 8, containing 1 to 10% by weight of amitraz.

10. A solid shaped article of a polyvinyl chloride matrix comprising
1 to 30% by weight of a glycerol ester or propylene glycol ester with C₈-C₁₂-fatty acids, and
optionally an adjuvant additive,
wherein the shaped article has a thickness from 0.5 to 20 mm and includes one or more openings passing therethrough having a width of 6-9 mm.

11. A solid shaped article according to claim 10, wherein the glycerol ester or propylene glycol ester with C₈-C₁₂-fatty acids is caprylic/capric acid triglyceride or propylene glycol dicaprylate/dicaprate.

12. A solid shaped article according to claim 1, comprising propylene glycol dicaprylate/dicaprate.

13. A solid shaped article according to claim 1, including 10 to 100 openings.

14. A beehive comprising a solid shaped article according to claim 1.
